(19) United States
(12) Patent Application Publication
(10) Pub. No.: US 2020/0388171 A1
(43) Pub. Date: Dec. 10, 2020

(54) System for recording images of landing and departing aircraft

(71) Applicant: Sucxess LLC, Birmingham, MI (US)

(72) Inventor: Axel Nix, Birmingham, MI (US)

(21) Appl. No.: 16/946,046

(22) Filed: Jun. 4, 2020

Related U.S. Application Data
(60) Provisional application No. 62/857,013, filed on Jun. 4, 2019.

(51) Int. Cl. G08G 5/02; G08G 5/00

(52) U.S. Cl. CPC G08G 5/025; G08G 5/0082; G08G 5/0026; G08G 5/0043; G08G 5/0078

(57) ABSTRACT

An unconventional application of ADS-B data emitted from an aircraft includes a system for recording video images of landing aircraft. The system uses a camera with motorized pan and tilt. The pan and tilt are controlled by a control logic based on ADS-B position data received from a landing aircraft. Another unconventional use of ADS-B data relates to optimized scheduling of an ADS-B equipped aircraft with automated schedule updates and user interactions based on ADS-B data received from the scheduled aircraft.

### TECHNICAL FIELD

The present disclosure relates systems and methods for scheduling and monitoring ADS-B equipped aircraft and for recording images of landing and departing aircraft.

### BACKGROUND

Automatic dependent surveillance-broadcast (ADS-B) is a surveillance technology in which an aircraft determines its position via satellite navigation and periodically broadcasts its position, enabling it to be tracked. The information can be received by air traffic control ground stations as a replacement for secondary surveillance radar, as no interrogation signal is needed from the ground. It can also be received by other aircraft to provide situational awareness and allow self-separation. ADS-B is “automatic” in that it requires no pilot or external input. It is “dependent” in that it depends on data from the aircraft's navigation system.

ADS-B provides significant advantages to pilots and air traffic controllers by improving situational awareness. Pilots benefit from knowing the exact position and altitude of other aircraft, making it easier to avoid other traffic.

This paper discloses secondary benefits that can be derived by processing ADS-B data in unexpected ways.

### SUMMARY

A system for recording video images of landing aircraft includes a camera with motorized pan and tilt, an ADS-B receiver, and a control logic. The control logic is operatively connected to the camera and to the ADS-B receiver. The control logic is configured to select, based on a set of selection criteria, one of multiple aircraft within range of the ADS-B receiver. The control logic then directs the camera, by controlling the camera's motorized pan and tilt, such that the selected aircraft is within the camera's field of view.

The control logic receives, processes, and stores data from the multiple aircraft. The set of selection criteria is stored in a non-volatile memory in the control logic. The set of selection criteria include one or more of a distance between the multiple aircraft and the camera, an altitude of the multiple aircraft, a speed of the multiple aircraft, and a heading of the multiple aircraft.

The control logic may calculate a score for each of the multiple aircraft and selects the one of the multiple aircraft with the highest score. The set of selection criteria may include information identifying a preferred runway, for example if two or more systems are used and each of the two or more systems is associated with a preferred runway.

The control logic may calculate an azimuth and elevation of the selected aircraft and control the motorized pan and tilt of the camera in response to the calculated azimuth and elevation. The control logic may also calculate a distance of the selected aircraft and control a zoom of the camera in response to the calculated distance.

The control logic may identify a landing or a take-off condition of the selected aircraft and record a video clip of the identified landing or take-off.

The system may include an image processing module operatively connected to the camera and configured to detect aircraft in images captured by the camera. The camera's pan and tilt may then be controlled based on a position of the selected aircraft in the captured images. In particular, the camera's pan and tilt may be controlled to maintain a target position of the selected aircraft in the captured images.

A system for scheduling an ADS-B equipped aircraft includes an ADS-B receiver and a scheduler. The ADS-B receiver is operatively connected to the scheduler. The scheduler contains a database which associates users through a schedule with aircraft. The scheduler is configured to transmit a message to one of the users in response to information received from the ADS-B receiver or in response to an absence of information received from the ADS-B receiver.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 shows a system diagram of a system for scheduling and monitoring ADS-B equipped aircraft.

FIG. 2 is a sequence diagram showing the interaction of a user, a scheduler, and an ADS-B receiver.

FIG. 3 is a state diagram showing various states that an ADS-B equipped aircraft may be associated with.

FIG. 4 is a block diagram showing a system for monitoring an ADS-B equipped aircraft with a camera.

FIG. 5 is a block diagram showing a system for monitoring availability of a runway.

FIG. 6 is a functional block diagram of a camera control device.

### DETAILED DESCRIPTION

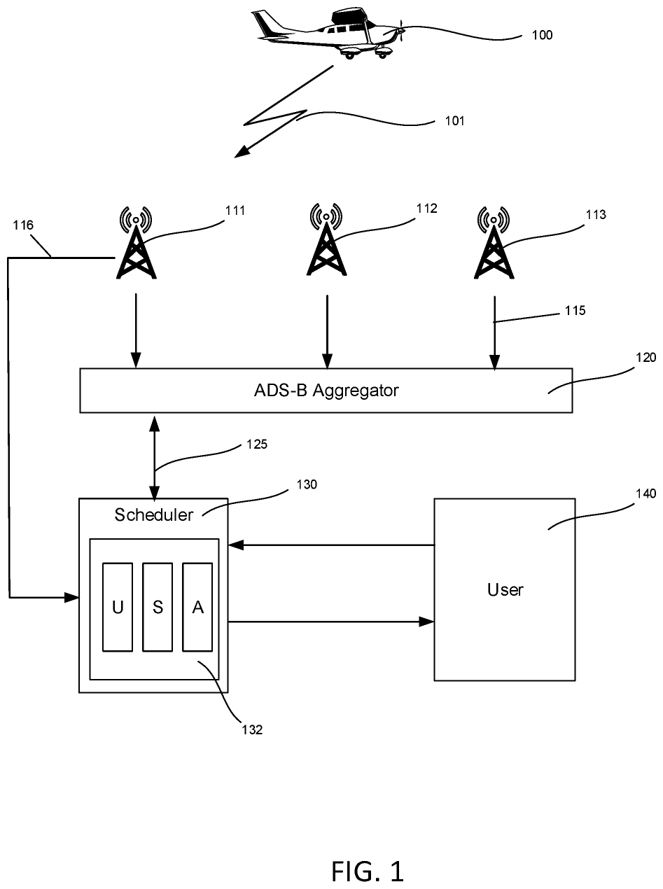

FIG. 1 shows a system diagram of a system for scheduling and monitoring an ADS-B equipped aircraft 100. The system includes one or more ADS-B receivers 111,112,113 which are configured to receive ADS-B messages 101 from the aircraft 100. The messages 101 are 1090 MHz Extended Squitter (ES) or 978 MHz Universal Access Transceiver (UAT) messages.

The ADS-B receivers 111,112,113 may be geographically spread out and operatively connected to an ADS-B aggregator 120. The ADS-B aggregator 120 may receive data from the ADS-B receivers through a network 115, e.g. the internet. The ADS-B aggregator 120 may track the position of the aircraft 100 beyond the range of any single ADS-B receiver. The ADS-B aggregator 120 is in bidirectional communication with a scheduler 130 which maintains scheduling information. The scheduling information includes user reservations of the aircraft 100. Alternatively, or additionally, the scheduler 130 may be in direct communication 116 with an ADS-B receiver 111, which is preferably installed in geographic proximity of a home base of the aircraft 100.

The scheduler 130 may be server system which is connected to and accessible through the internet. It may also be referred to as a scheduling system or schedule server. The scheduler 130 may include a database 132 which associates user identities U through a schedule S with aircraft A. The user identities U may include a username, user login information, and user contact information. The user contact information may include a telephone number or an email address. The aircraft information A may include an aircraft identifier, e.g. a tail-number, and an aircraft type. The schedule information S may associate a user with an aircraft for a given time period, e.g. “user Tom Smith has reserved aircraft N526BL on Mar. 30, 2021 from 11.00 am to 2.00 pm”.

One problem with existing schedulers 130 is that they are manually updated by users or administrators, which can lead to numerous disadvantageous situations: No-shows of users may lead to an aircraft being scheduled for an extended period of time without being used. Delayed users may lead to an aircraft not being available for the next scheduled user on time. Early returns may block aircraft from being scheduled by other users longer than necessary.

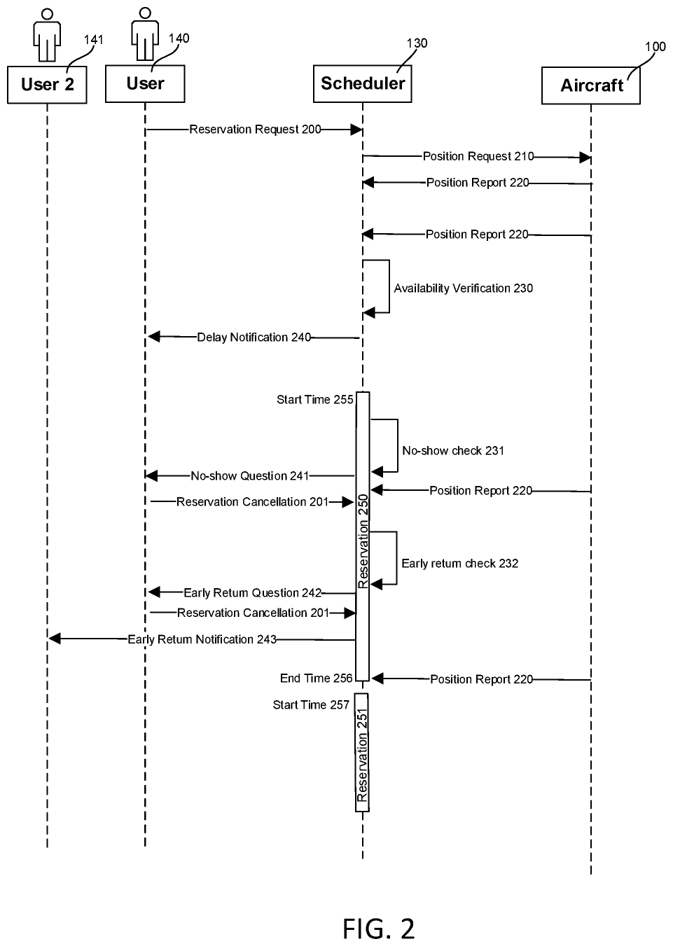

The sequence diagram shown in FIG. 2 illustrates how the improved scheduling system shown in FIG. 1 can address these shortcomings. A user 140 may interact with the scheduler 130 to create a reservation 250. This is accomplished by sending a reservation request 200 from the user 140 to the scheduler 130. This reservation request 200 may be entered through a web interface or a mobile app. If the aircraft 100 is available, the reservation 250 will be created. The reservation 250 includes a start time 255 and an end time 256.

The scheduler interacts with the aircraft 100 by receiving position reports 220. Information from the aircraft 100 may be received directly, or indirectly from an ADS-B aggregator. The ADS-B aggregator may make position reports 220 available based on a position request message 210 sent from the scheduler 130 to the ADS-B aggregator, either on a case-by-case basis or by subscribing to position events.

Before the start time 255 of the reservation 250 the scheduler 230 performs an availability verification 230. The availability verification utilizes the most recent position report 220 to determine the present position of the aircraft 100. The present position of the aircraft may be a memorized value while the aircraft is not actively transmitting position reports through ADS-B, e.g. because the aircraft has been parked and the ADS-B transmitter in the aircraft has been turned off. The availability verification 230 may include calculating a distance between the present position of the aircraft 100 and its home base. This distance may be calculated based on the latitude and longitude information received in the most recent position report 220 and a home base latitude and longitude. The home base latitude and longitude may be stored in the scheduler 130 within the database 132, and may be part of an aircraft record A within the database 132. The availability calculator may divide the distance by speed to determine a time. The speed may be a present ground speed of the aircraft 100 which may be part of or derived from position reports 220. Alternatively, the speed may be a database entry associated with the aircraft 100. The time may be indicative of a minimum amount of time the aircraft 100 will need to return from its present position to its home base. This time will be referred to as the time to home. A programmable offset may be added to the time to home to account for taxing, shutdown, and cleaning of the aircraft until it is ready to be used by a new user.

If the time to home exceeds the duration between the reservation start time 255 and the present time the aircraft a delay notification 240 may be sent to the user 140. The delay notification may be sent in form of a text message, app notification, email or the like. The delay notification may include information relating to the present position of the aircraft 100, information relating to the user having scheduled the aircraft before the reservation 250, and the calculated time to home.

The availability verification 230 may be performed multiple times before the start time 255, e.g. in 15-minute intervals beginning 4 hours before the start time 255.

The scheduler 130 may perform a no-show check 231 at a predetermined time after the start time 255 of the reservation 250. The no-show check 231 may verify that a position report 220 has recently been received, e.g. within the previous 30 seconds. If no position report 220 has recently been received the scheduler 130 may send a no-show question 241 to the user 140. The no-show notification may provide the user 140 a convenient way to either cancel the reservation 250 and make the aircraft 100 available to other users or to confirm the reservation. For example, the no-show notification may be phrased in form of a question whether to cancel the reservation 250 and sent in a text message to the user's mobile phone. The user may interact with the scheduler 130 by simply replying “yes” to send a reservation cancellation 201 to the scheduler 130.

Periodically, throughout the reservation 250, the scheduler 130 may perform early return checks 232. An early return may be recognized if the most recent position report 220 shows the aircraft 100 within an area of the home based where the aircraft is typically parked. If an early return is recognized, the scheduler 130 may transmit an early return notification 242 to the user 140, motivating the user to reply with a reservation cancellation 201. If a reservation cancellation is received, the scheduler 130 may release the aircraft to other users. The scheduler 130 may transmit an early return notification 243 to a second user 141 who is associated with a subsequent reservation 251, indicating that the aircraft is available before the second user's reservation start time 257.

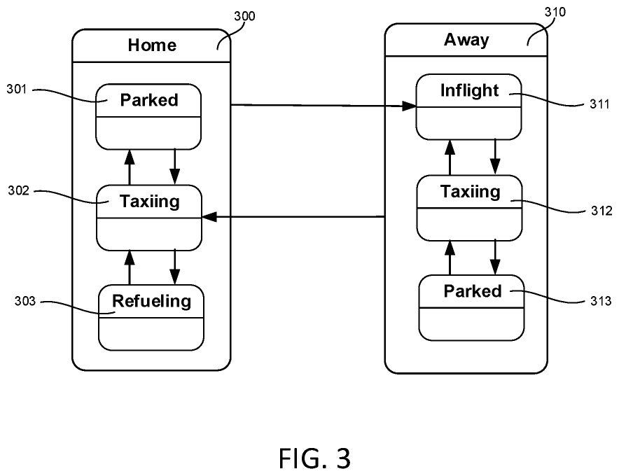

FIG. 3 shows an example of a state machine that may be used in the scheduling and monitoring an ADS-B equipped aircraft 100. The state machine may include a “home” state 300 and an “away” state 310. The home state may be divided into sub-states, namely a “parked” state 301, a “taxiing” state “302” and a “refueling” state 303. The away state may be divided into sub-states, namely an “inflight” state 311, a “taxiing” state 312 and a “parked” state 313.

The state machine may transition from the home state 300 to the away state 310 upon takeoff of the ADS-B equipped aircraft 100. The transition may be based on an aircraft speed exceeding a predetermined minimum flight speed threshold. For example, the state machine may transition into the inflight state 311 any time the ground speed of the aircraft 100 exceeds 50 knots.

Similarly, the state machine may transition out of the inflight state 311 any time the aircraft ground speed falls below a predetermined maximum taxi speed threshold, e.g. when the aircraft ground speed falls below 10 knots. The difference in speed used to transition into the inflight state 311 and out of the inflight state 311 creates a hysteresis to prevent rapid and false state changes.

The state machine may transition from the away state 310 to the home state if the aircraft ground speed is below the maximum taxis speed threshold and the position of the aircraft 100, as indicated by its latitude and longitude ADS-B broadcast, is within a preselected geographic area identified as the aircraft's home base. A smaller geographic area within the home base area may be used to identify a refueling position, e.g. the location of a self-service fuel pump. The state machine may transition from the taxiing state 302 to the refueling state 303 if the aircraft's position is within the geographic area associated with a fuel pump and the aircraft 100 fails to broadcast ADS-B messages for longer than a predetermined time.

The state machine may transition into a parked state 301, 313 whenever the aircraft 100 fails to broadcast ADS-B messages for longer than a predetermined time, indicating that its electrical system, including its ADS-B transmitter, have been turned off.

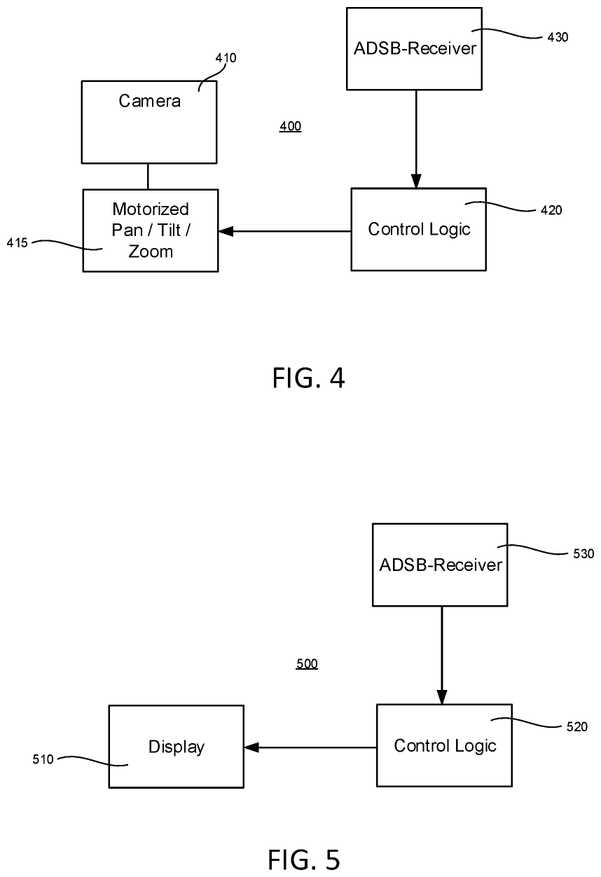

It may be desirable to collect and make available photographs and/or video data relating to an ADS-B equipped aircraft 100. A suitable system 400 is generally shown in FIG. 4. The system includes a camera 410 with motorized pan, tilt and zoom 415 (also referred to as a PTZ camera). The camera is operatively connected to a control logic 420, which may be a small computer including a programmable processor. The control logic 420 is operatively connected to an ADSB-receiver 430.

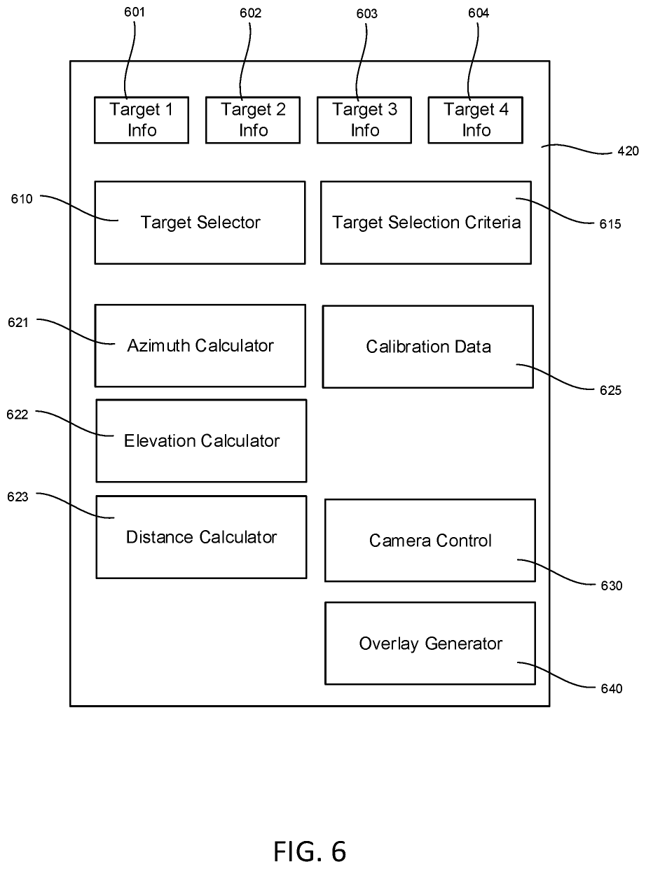

A functional block diagram of the control logic 420 is shown in FIG. 6. The control logic receives and processes data 601, 602, 603, 604 from ADS-B equipped aircraft which is at least temporarily stored within a memory in the control logic 420. Typically, the ADS-B receiver 430 may receive data from several aircraft flying within range of the ADS-B receiver 430. A target selection mechanism 610 is used to decide which of the multiple targets the camera 410 should be pointed at. The target selection mechanism may utilize one or more target selection criteria 615 which may be stored in a non-volatile memory within the control logic 420.

The target selection criteria 615 may include distance between target and camera, altitude of the target, speed of the target, heading of the target. The target selection criteria may also include preference values. For example, a high value of 100 may be associated with an aircraft which, based on received ADS-B data, has been identified as being on short final/within 30 sec of touchdown. A somewhat lower score of 50 may be associated with departing aircraft, while an even lower score of 30 may be associated with an aircraft that is taxiing.

The target selection criteria 615 should be configured to identify at least landing and departing aircraft. At large airports, the target selection criteria may also consider a preferred runway. For example, a first camera may be used to observe a first runway, while a second camera is used to observe a second runway. In use, the first camera may be directed at a first aircraft landing on a first runway while the second aircraft is directed at a second aircraft departing from a second runway. That is, the second camera has a higher preference score for departing aircraft using the second runway than landing aircraft using the first runway.

For a selected target the control logic 420 calculates the target's azimuth, elevation and distance. The corresponding azimuth calculator 621, elevation calculator 622, and distance calculator 623 use the selected target's latitude, longitude and altitude in combination with known camera position and orientation. The known camera position and orientation may be stored in non-volatile memory as indicated by a calibration data block 625.

The calculated azimuth, elevation and distance are used to control the PTZ-motors 415 of the camera 410. A camera control module 630 may be used to translate the calculated azimuth, elevation and distance into camera-specific pitch, tilt and zoom commands.

The control logic 420 may also include an overlay generator 640 which superimposes data related to the selected target onto a video stream from the camera 410. The superimposed data may e.g. include the selected target's identifier, such as a tail number of flight number, speed, and altitude. The control logic 420 may be configured to record a video clip of a landing or departing aircraft and upload the recorded clip to a video sharing website.

A differently configured system 500 is shown in FIG. 5. Here, a control logic 520 is operatively connected to a display 510 and an ADS-B receiver 530. The control logic 520 may implement one or more of the modules shown in FIG. 6, in particular the target selector 610. The control logic 520 may be used to indicate that an aircraft is approaching a particular runway, and the display 510 may be used to alert other aircraft to the approaching traffic. For example, the control logic 520 may be used to identify a landing aircraft and activate a light 510 when the landing aircraft is within 30 sec of touchdown.

The camera 410 may include object detection capability based on image processing. In that case the control logic 520 may be used to roughly direct the camera 410 into the right direction, and activate visual object tracking within the camera 410 for continued tracking of an aircraft within the camera's field of view.

Throughout this specification and the following claims, the indefinite article “a” or “an” does not exclude the possibility that more than one of the element is present, unless the context clearly requires that there is one and only one of the elements. The indefinite article “a” or “an” thus usually means “at least one”. The coordinating conjunction “or” is not used to express exclusivity. A reference to “A or B” being present is true if A alone is present, B alone is present, or both A and B are present.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A system for recording images of landing and departing aircraft, comprising:
a camera with motorized pan and tilt, the camera having a field of view;
an ADS-B receiver; and
a control logic operatively connected to the camera and to the ADS-B receiver;
wherein the control logic is configured to select, based on a set of selection criteria, one of multiple aircraft within range of the ADS-B receiver and direct the camera, by controlling the camera's motorized pan and tilt, so that the selected aircraft is within the camera's field of view.

2. The system as in claim 1,
wherein the control logic receives, processes, and stores data from the multiple aircraft.

3. The system as in claim 1,
wherein the set of selection criteria is stored in a non-volatile memory in the control logic.

4. The system as in claim 1,
wherein the set of selection criteria include one or more of
a distance between the multiple aircraft and the camera,
an altitude of the multiple aircraft,
a speed of the multiple aircraft, and
a heading of the multiple aircraft.

5. The system as in claim 1,
wherein the control logic calculates a score for each of the multiple aircraft and selects the one of the multiple aircraft with the highest score.

6. The system as in claim 1,
wherein the set of selection criteria includes information identifying a preferred runway.

7. The system as in claim 1,
wherein the control logic calculates an azimuth and elevation of the selected aircraft and controls the motorized pan and tilt of the camera in response to the calculated azimuth and elevation.

8. The system as in claim 1,
wherein the control logic calculates a distance of the selected aircraft and controls a zoom of the camera in response to the calculated distance.

9. The system as in claim 1,
wherein the control logic identifies a landing or a take-off of the selected aircraft and records a video clip of the identified landing or take-off.

10. The system as in claim 1,
further comprising an image processing module operatively connected to the camera and configured to detect aircraft in images captured by the camera.

11. The system as in claim 10,
wherein the camera's pan and tilt is controlled based on a position of the selected aircraft in the captured images.

12. The system as in claim 11,
wherein the camera's pan and tilt is controlled to maintain a target position of the selected aircraft in the captured images.

13. A system for recording images of landing and departing aircraft, comprising:
a first camera with motorized pan and tilt, the first camera having a first field of view;
a second camera with motorized pan and tilt, the second camera having a second field of view;
a first ADS-B receiver;
a second ADS-B receiver;
a first control logic operatively connected to the first camera and to the first ADS-B receiver;
a second control logic operatively connected to the second camera and to the second ADS-B receiver;
wherein the first control logic is configured to select, based on a first set of selection criteria, a first aircraft of multiple aircraft within range of the first ADS-B receiver and direct the first camera, by controlling the first camera's motorized pan and tilt, so that the selected first aircraft is within the first camera's field of view, and
wherein the second control logic is configured to select, based on a second set of selection criteria, a second aircraft of multiple aircraft within range of the second ADS-B receiver and direct the second camera, by controlling the second camera's motorized pan and tilt, so that the selected second aircraft is within the second camera's field of view.

14. The system as in claim 13,
wherein the first set of selection criteria includes information relating to a first runway and
wherein the second set of selection criteria includes information relating to a second runway.
